(19) United States
(12) Patent Application Publication
(10) Pub. No.: US 2011/0012838 A1
(43) Pub. Date: Jan. 20, 2011

(54) COMPUTER INPUT DEVICE INCLUDING A DISPLAY DEVICE

(75) Inventors: Aleksandar Pance, Saratoga, CA (US); Brett Bilbrey, Sunnyvale, CA (US); Duncan Kerr, San Francisco, CA (US)

Correspondence Address: SCHWEGMAN, LUNDBERG & WOESSNER/APPLE, PO BOX 2938, SUITE 300, MINNEAPOLIS, MN, 55402, US

(73) Assignee: Apple Inc., Cupertino, CA (US)

(21) Appl. No.: 12/502,644

(22) Filed: Jul. 14, 2009

(51) Int. Cl. G06F 3/041; G09G 5/00

(52) U.S. Cl. 345/173; 345/156

(57) ABSTRACT

In an embodiment, an input device, such as computer mouse, includes an interface to communicate user interactions to a host system and a display assembly to display an image to a user. In some examples, the display device will include a collimated glass component. A method is disclosed that includes displaying an image at an input device, such as a mouse, and then displaying a second image in response to a user input through the input device.

### BACKGROUND

The present disclosure relates generally to a computer input device a display device, and more particularly relates to an input device using such display to convey visually observable data such as colors and images to a user of the input device. In some applications, the visually observable data may be present at a surface of the input device.

Many forms of input devices are known for use with computers and other forms of processing system. For example, keyboards may be both actual and virtual; many forms are known for computer “mice”; and other input devices such as track balls and trackpads are known, as well as many types of devices generally used for providing inputs to gaming platforms. Additionally, otherwise conventional devices such as phones may be used for providing inputs to different types of processor-based systems. In particular, the iPhone manufactured by Apple Inc., of Cupertino, Calif. may be used with appropriate software to provide inputs to control a wide range of processor-based systems, including computers, set-top boxes, audio-video equipment, and other devices.

While sophisticated devices such as the iPhone provide significant information to a user regarding use of the device as a controller. For more common and basic input devices, such as keyboards, mice, trackpads, tablets, etc., functionality available through the input device is not usually conveyed through the input device, but, if at all, through the user interface on the system to which inputs are provided. As a result, it is not always apparent to the user which input should be used to access particular application functions; the functionality to a user might be improved through a more communicative input device.

Separate from the above concern, even if input devices provide satisfactory mechanisms for providing physical inputs to a processing system, they are not necessarily always aesthetically pleasing. Thus, mechanisms that would provided options to improve the appearance to a user, such as, for example, user customization of appearance, have the potential to improve the user experience with the input device, even apart from adding functionality

Accordingly, this disclosure identifies new configurations for use in input devices that provide functionality and appearance options beyond those available in current input devices.

### SUMMARY

In an embodiment, an input device, such as a computer mouse, includes an display device to present observable data to a user. In some examples, the observable data may form a portion of an interface to communicate user interactions to a host system. In some desirable configurations, the input devices will include a collimated glass component configured to translate an image from the display device to a surface of the input device, for example, an outer surface. In such examples, the collimated glass component preferably includes a plurality of fused optical fibers and an input interface, and the fused optical fibers convey optical data, such as image data, from the input interface to the outer surface of the collimated glass component.

In another example, a method is disclosed that includes displaying an image on the input device. In some examples, the image may be received at the input device, such as a mouse, while in other examples, the image may be stored in the input device. The input device is communicatively coupled to a computing system. In such examples, The input device can be any device configured to communicate user input selections to the computing system, including a personal digital assistant, a mobile telephone, a mouse, a graphics pad, a keyboard, and other input devices.

Many additional structural and operational variations that may be implemented in various examples of the inventive subject matter are provided in the description that follows.

### BRIEF DESCRIPTION OF THE DRAWINGS

FIG. 1 depicts a computing system including an input device with a collimated optical component in an example configuration.

FIG. 2 depicts the system of FIG. 1, illustrated in block diagram form.

FIGS. 3A-C depict side views of different configurations of a collimated optical component.

FIG. 4 depicts an example of a mouse input device with a collimated optical component, as depicted in FIGS. 1 and 2, with a touch-sensitive interface and including translated image data as an example of one possible implementation.

FIG. 5 depicts an alternative embodiment of an input device having a optical component that is configured to communicate with a computing system, such as the computing system of FIG. 1.

FIG. 6 depicts a flow diagram of an example illustrative embodiment of a method of operating a computing system via an input device including a optical component.

### DETAILED DESCRIPTION

The following detailed description refers to the accompanying drawings that depict various details of examples selected to show how particular embodiments may be implemented. The discussion herein addresses various examples of the inventive subject matter at least partially in reference to these drawings and describes the depicted embodiments in sufficient detail to enable those skilled in the art to practice the invention. Many other embodiments may be utilized for practicing the inventive subject matter than the illustrative examples discussed herein, and many structural and operational changes in addition to the alternatives specifically discussed herein may be made without departing from the scope of the inventive subject matter.

In this description, references to “one embodiment” or “an embodiment,” or to “one example” or “an example” mean that the feature being referred to is, or may be, included in at least one embodiment or example of the invention. Separate references to “an embodiment” or “one embodiment” or to “one example” or “an example” in this description are not intended to necessarily refer to the same embodiment or example; however, neither are such embodiments mutually exclusive, unless so stated or as will be readily apparent to those of ordinary skill in the art having the benefit of this disclosure. Thus, the present disclosure includes a variety of combinations and/or integrations of the embodiments and examples described herein, as well as further embodiments and examples as defined within the scope of all claims based on this disclosure, as well as all legal equivalents of such claims.

For the purposes of this specification, “computing device,” “computing system,” “processor-based system” or “processing system” includes a system that uses one or more processors, microcontrollers and/or digital signal processors and that has the capability of running a “program.” As used herein, the term “program” refers to a set of executable machine code instructions, and as used herein, includes user-level applications as well as system-directed applications or daemons, including operating system and driver applications. Processing systems can include communication and electronic devices, such as mobile phones (cellular or digital), music and multi-media players, and Personal Digital Assistants (PDA); as well as computers, or “computing devices” of all forms (desktops, laptops, servers, palmtops, workstations, etc.).

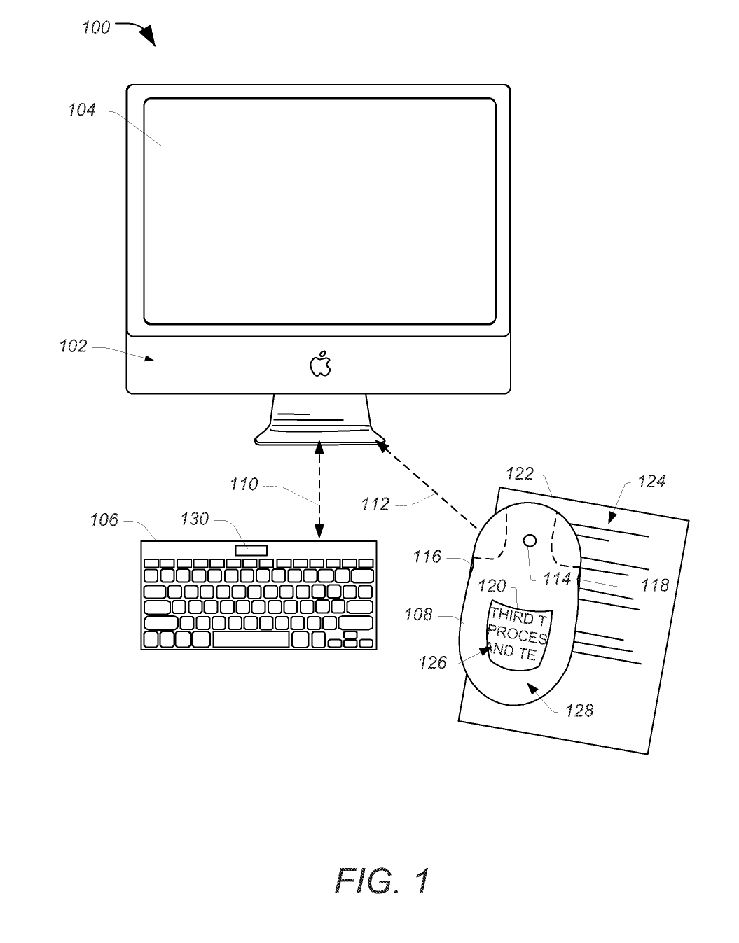

As will be discussed below in detail with respect to FIGS. 1-5, input devices and associated methods are disclosed. In these examples, the input device includes a collimated optical component. For purposes of the present description the collimated optical component will be described as being formed of collimated glass. As used herein, “collimated glass” refers to an optical component that includes a plurality of optical fibers, such as glass fibers or other “fiber optic” fibers, that are fused together in a generally uniform arrangement. Examples of such collimated glass are marketed by Schott North America, Inc. of Southbridge, Mass. Because of the uniform arrangement of the fused optical fibers, light and light patterns (i.e., images) entering the optical component at a first surface are generally uniformly transmitted through the component, and appear at the surface at the other end of the component. Thus, as will be described in more detail below, such a collimated glass component may be used to convey optical data from a first interface to a viewing surface such that optical data appears to lie essentially at the viewing surface. Additionally, the collimated glass component need not be uniform, but, for example, the individual fibers may be expanded along their length, thereby fanning out to a larger surface, and thus presenting a larger output image than the image input to the component. Other changes in the fiber configuration, and thus the image presentation, are also possible.

Referring now to FIG. 1 therein is depicted a processing system 100 that includes computing device 102 with a built-in display 104. Computing device 102 is configured to communicate with a variety of peripheral devices, including, for example, keyboard 106 and mouse 218. Computing device 102, keyboard 106, and mouse 218 are typically supported by a planar surface (not shown), such as a table top or a desk. Keyboard 106 and mouse 108 are each adapted to communicate with computing device 102 through a respective wired or wireless communications link 110 and 112, respectively. In this example, mouse 108 is configured to provide positioning information (including directional information and speed of movement information) to computing device 102 primarily in response to sliding movement of mouse 108 relative to an underlying support surface through use of an optical tracking engine.

Mouse 108 includes scroll ball 114, left and right touch sensitive regions 116 and 118, and a collimated glass component 120 that extends from a lower surface of mouse 108 to form a portion of the upper surface 128 of mouse 108. Mouse 108 is depicted resting on a sheet of paper 122 with text 124. In this particular example, collimated glass component 120 is configured (through expansion of the bundled fibers, as identified earlier herein) to display a magnified image 126 of underlying text 124. While this is a possible example use of the collimated glass component in an input device, other uses are also anticipated, and the present example is provided primarily to illustrate the capabilities of the collimated glass component.

In other examples, either a smaller or a larger portion of the mouse shell 108 may be formed from collimated glass. Additionally, as will also be discussed later herein, the collimated glass component display surface may be placed under another surface, such as a passive transparent surface or a touch screen interface. Additionally, in other examples, many types of optical data may be communicated through the collimated glass component to a user, in some cases to inform or assist the user in interfacing with the computer system. For example, the optical data may provided originate at a display device (such as, for example, an LED, LCD, OLED, or TFT display), that is cooperatively arranged relative to an input surface of a collimated glass component to facilitate translation of the image data through the component. As identified earlier herein, the use of a collimated glass component is not essential, as a display may be provided at a viewable surface of the input device. For example, the collimated glass component translates an image to such a viewable surface, so the alternative structure is to dispose the display at the same viewable surface. Additionally, even where non-planar surfaces are involved, the displays may be configured to match the surface contours. Also, certain display types, such as OLED displays are capable of being constructed of flexible components, further facilitating use on non-planar surfaces.

In some examples, the image data to be presented on the display device may be stored in the mouse, or it may be provided from computing system 102 to the imaging device in mouse 108 through communications link 112. Although a wide variety of applications are possible, as just a few examples, the displayed image data might include one or more of text, input locations such as virtual buttons, still or video images, and colored light that is either static or changing. As an example, soft-key information, such as text labels, can be displayed, for example, adjacent to left and right touch sensitive regions 116 and 118 to provide labels indicating functionality available by selection through such regions.

Further, the input device could include a collimated glass component 120 having a display surface near or beneath a touch screen interface, by which different patterns of virtual buttons may be displayed at the display surface of the component and be visible at the touch screen surface to customize and/or guide user input. Where the collimated glass component is to be used in combination with touch screen technology, the touch surface will typically extend over the top of the collimated glass component. In such examples, any touch screen technology can be used, including resistive, capacitive, and other sensing technologies. Preferably, the touch screen sensing components will be translucent or so small as to be visually unobtrusive or undetectable to a user.

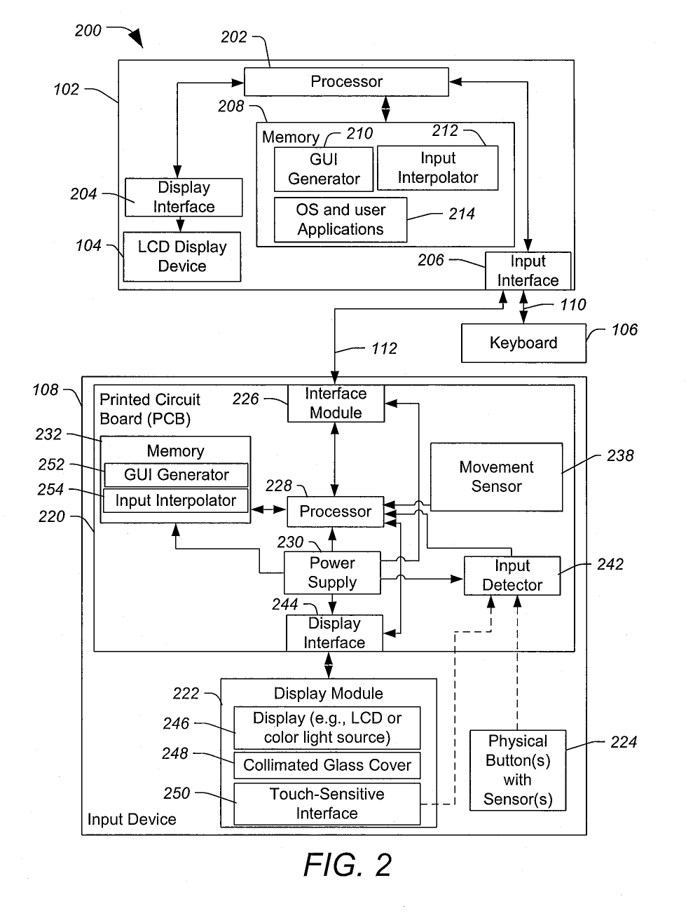

FIG. 2 depicts an example processing system 200 configuration, illustrated in block diagram form, including both a computing system such as computing system 102 of FIG. 1, and an example input device, again described in the example of a mouse 218. In this example, mouse 218 utilizes the collimated glass component in combination with a touch screen interface, and facilitates a variable GUI accessible for that touch screen interface.

Computing system 102 includes one or more processors 202 (discussed here, for convenience, as a single processor) coupled to display interface 204, which is coupled to display 104, such as a flat panel LED display device. Processor 202 is also coupled to various peripheral devices, including keyboard 106 and mouse 218 through input interface 206. Processor 202 is coupled to memory 208 to retrieve and execute stored instructions executable by one or more processors, including, for example, both operating system instructions and user application instructions 214. Processor 202 executes GUI generator module 210 to produce data defining images for presentation on display 104. In the depicted example GUI generator module 210 will also generate data defining images to be displayed through mouse 218. Additionally, processor 202 selectively executes input interpolator module 212 to process input data received from input devices, such as mouse 218. In other examples, wherein the input device is of another type, such as a transparent track pad, such user input data may reflect a different type of input data, and input interpolator module 212 will be executed by processor 202 to determine user inputs provided through that device. As mentioned above, certain systems, apparatus or processes are described herein as being implemented in or through use of one or more “modules.” A “module” as used herein is an apparatus configured to perform identified functionality through software, firmware, hardware, or any combination thereof When the functionality of a module is performed in any part through software or firmware, the module includes at least one machine readable medium bearing instructions that when executed by one or more processors, performs that portion of the functionality implemented in software or firmware. The modules may be regarded as being communicatively coupled to one another to at least the degree needed to implement the described functionalities.

Mouse 218 includes a circuit, such as may be formed on a printed circuit board (PCB) 220, coupled to display module 222 and to one or more mechanical or electrically operated “buttons” 224 (such as scroll ball 114 and left and right touch sensitive regions 116 and 118 depicted in mouse 108 of FIG. 1). PCB 220 includes interface module 226 coupled to input interface 206 through communications link 112. A power supply 230, such as a battery, supplies power to interface module 226 and to all of the components on PCB 220, as needed. Interface module 226 is also coupled to processor 228 to communicate data received from computing system 102 and to receive data for transmission to computing system 102. In the depicted example, interface module 226 includes a short-range wireless transceiver, such as a Bluetooth®-enabled transceiver.

Processor 228 is coupled to a movement sensor 238, which is adapted to detect movement of mouse 218 relative to an underlying surface. As noted previously, movement sensor 238 can include trackball sensors, optical sensors, vibration sensors, or any other sensor(s) configured to provide outputs indicative of directional movement and speed. Processor 228 is also coupled to memory 232, which can include instructions executable by processor 228 to perform a variety of functions. In the depicted example, memory 232 includes GUI generator module 252 and input interpolator module 254, which may be executed by processor 228 to perform functions such as those described above with respect to GUI generator module 210 and input interpolator module 212, except that GUI generator module 252 and input interpolator module 254 are executed by processor 228 within mouse 218.

Processor 228 is also coupled to display interface 244 to provide image data to display module 222. Display module 222 includes a display device 246, which may be of any appropriate type for the application, including the examples described earlier herein. Display module 222 further includes collimated glass component 248 and touch screen interface 250. In this example, display module 222 receives image data from processor 228 through display interface 244, and provides the received image data to display device 246, which displays the intended image. Collimated glass component 248 is placed above display device 246 and thus receives the image at an input surface and translates the image to its display surface. For purposes of the present example, the image may be considered as a group of icons, displayed beneath, but in registry with, established contact regions of the touch screen interface. User interactions with locations on the touch screen interface in reference to the icons in the image displayed on collimated glass component 248 are detected by touch-sensitive interface 250 and communicated to input detector 242, which provides detection data to processor 228.

Image data for generating images on display device 246 may come from various locations. In some examples, the images may be presented from data stored in memory 232 in mouse 218. In other examples, the images may be presented from data received from computing system 102 through communications link 112.

In the depicted example, touch screen interface 250 is configured to generate an electrical signal based on a resistance, capacitance, impedance, deflection, or another parameter representing user contact with touch-sensitive interface 250. As is known to those skilled in the art, touch-sensitive interface 250 can include an array of capacitors or other circuit elements to determine a contact location. Alternatively, touch-sensitive interface 250 can detect user-interactions based on reflected light due to proximity of the user's finger (for example) at a particular location relative to the reflected light at other locations.

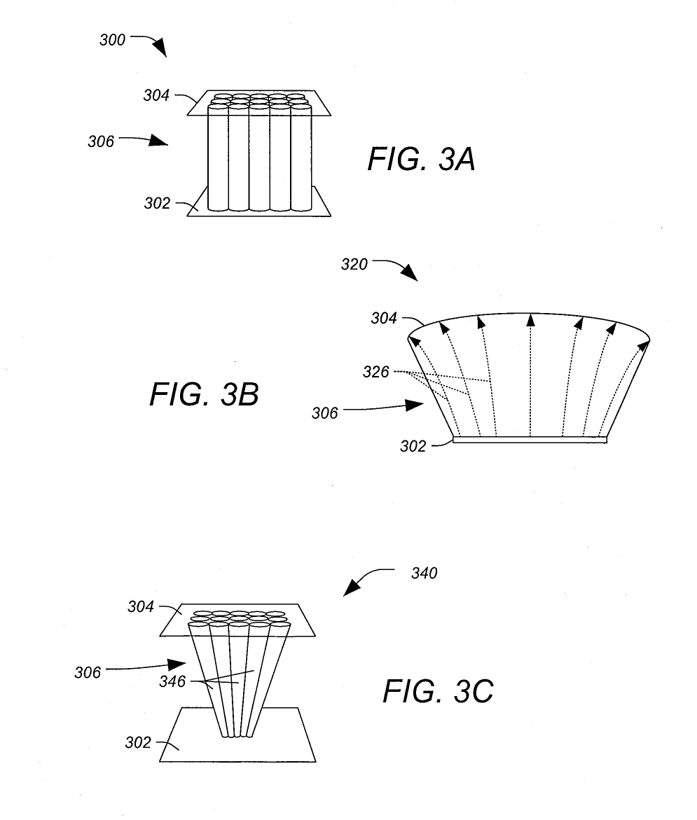

Referring now to FIGS. 3A-C, therein are depicted three illustrative examples of collimated glass components 300, 320, and 340. Each collimated glass component includes a respective image input interface 302, 322, 342; a respective glass element including fused optical fibers 306, 326, and 346; and a respective display interface 304, 324, 344; which cooperate to transmit and display image data at the identified display interface. In FIG. 3A, fused optical fibers 306 maintain a substantially consistent and straight cylindrical profile such that an image at input interface 302 is displayed (translated) at display interface 304 without substantial change. One feature of collimated glass, as noted earlier herein, is that the image at the input interface is not just visible down through the glass, as would be the case with any conventional transparent structure. Instead, with the collimated glass, the image appears to lie essentially at the display interface.

FIG. 3B depicts collimated glass component 320 wherein fused optical fibers 306 expand along their length, and thus the component curves to expand (as depicted by phantom arrows 326) and to display image data in magnified form on the broadened surface of display interface 344. FIG. 3C depicts still another collimated glass component 340 including fused optical fibers 346 that are substantially conically shaped, but which terminate at an essentially flat display surface 344. In an example, the conically shaped optical fibers again enlarge image data as it is translated from input interface 302 to collimated glass component 304.

Many other variations for the configuration of a collimated glass component can be envisioned. In general, a collimated glass component may be constructed to bend, stretch, magnify, or otherwise alter image data as it is translated from an input interface 302 to a display interface; and thus various configurations of a collimated glass component may be selected for a desired result for a specific application.

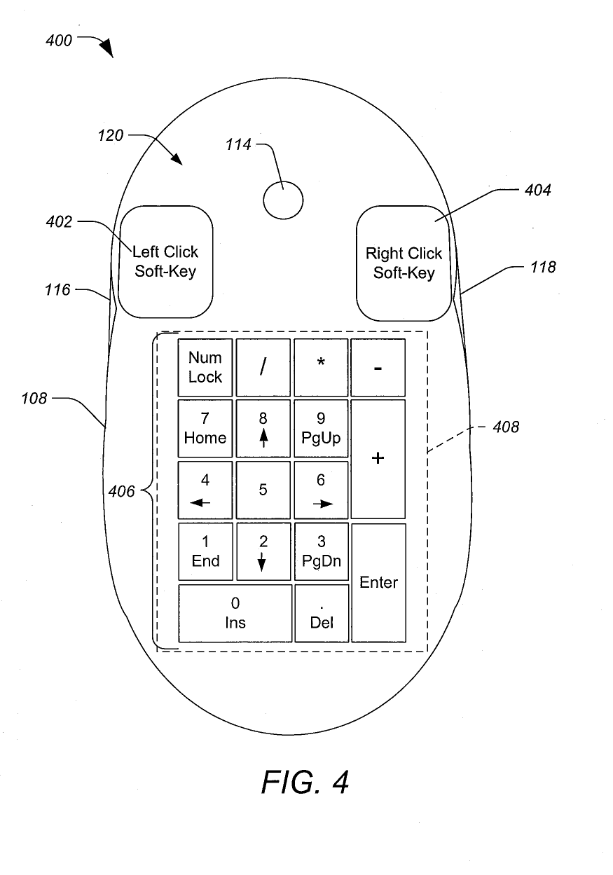

Referring now to FIG. 4, therein is depicted a physical representation of a mouse 400, such as might be implemented through a structure such as that described for mouse 218 of FIG. 2. In this embodiment, mouse 400 includes a touch screen interface at an area 408 of the surface of mouse 400, with a collimated glass component directly beneath the touch screen interface to display images at area 408, through the touch screen interface.

Mouse 400 includes touch sensors 402 and 404 that may be used for inputting inputs conventionally known as “left clicks” and “right clicks” in a manner known to those skilled in the art. In this example, a display device in mouse 400 displays the image of a keypad 406 which is translated through the collimated glass component to the display surface component, in registry with input locations for the touch screen interface. Through the combination of the display of keypad 406 in association with a touch screen interface, user inputs corresponding to keypad 406 may be provided through the touch screen interface, and may then be further processed in either mouse 400 or an attached computing system (not depicted) to provide appropriate keypad inputs for further use by the computing system. As one example of operation, a user might select a calculator function, which would then operate through a structure (such as that discussed in reference to FIG. 2), to: (i) display the keypad image 406, (ii) activate touch screen interface 408 to accept inputs through contact; and (iii) configure an input detector to interpret inputs to the touch screen as key pad inputs, in accordance with the displayed image.

To expand upon the depicted example, in response to another user input, mouse 400, or another input device having the basic described input functionality, might display a first set of one or more images (for example a first set of icons) representative of a first set of inputs under the touch screen interface if a word processing program such as if Pages™ of Apple Inc, was an active window on the computing system; and to then change the display images to a second set of one or more images if a spreadsheet program such as Numbers™ of Apple Inc. was the active window; with similar reconfiguring (or remapping) of the inputs to conform to the displayed image(s), as was described relative to keypad image 406. In this way, the surface could be configured to provide application-specific inputs, potentially with little or no input from the user. As another example, it can be seen that the above-described type of interface could provide enhanced input capability to a generally transparent trackpad.

As yet other alternatives, a user could elect to display one or more photos or videos, or even just colors or abstract patterns through an input surface. The capability of the collimated glass component to translate an input image to another size, shape or configuration for display provides a wide range of options to improve the user experience of an input device.

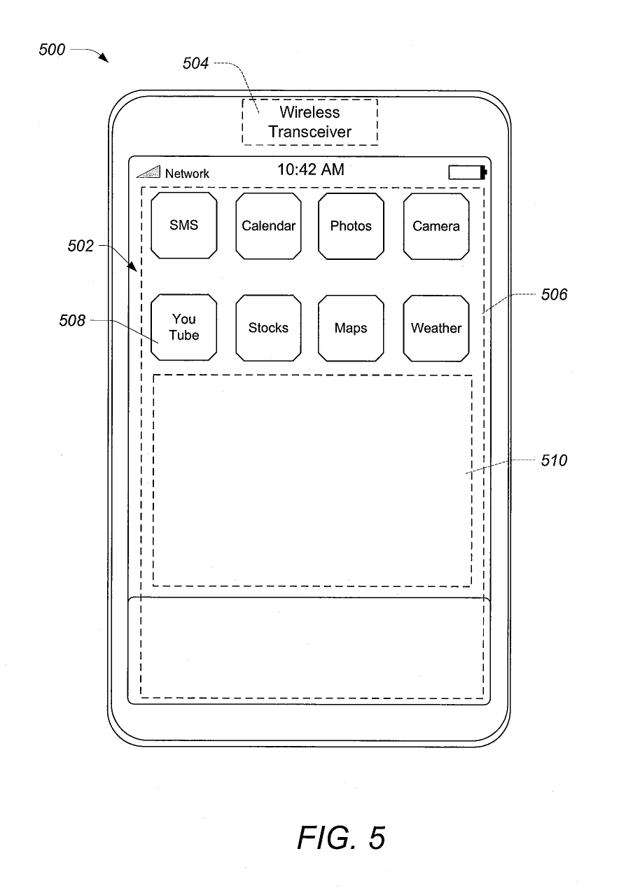

FIG. 5 depicts an alternative embodiment of an input device 500 having a display region 502 that is configured to communicate with a computing system, such as computing system 102 of FIG. 1. Display region 502 may include a conventional display device generally directly beneath a transparent surface, or may further include a collimated glass component as previously described herein. Input device 500 includes a transceiver, such as wireless transceiver 504 that is configured to communicate with the computing system. Alternatively or in addition to the wireless transceiver, input device 500 can include a communications interface configured to couple to a cable and to communicate with the computing system through the cable.

In this example, input device 500 will again provide a touch screen interface, and may be a “stand alone” touch interface device, or could have other functionality, such a one or more of a personal digital assistant (PDA), media player, communications device, etc. As with mouse 400, input device 500 includes a touch screen interface 506 displayed above the display region 502. In one example, input device 500 displays a plurality of icons, representing virtual buttons 508, on display region 502. Those virtual buttons are accessible by a user through interactions with touch-sensitive interface 506 to access specific functions, web pages, applications, or other features.

In an embodiment, buttons 508 are customizable for use by a particular user as a quick-access interface to launch applications and/or to access particular functionality of an associated computing system. In an example, various applications can be accessed by user input selection of buttons displayed on display region 502, including calendar, photo, camera, notes, calculator, mail, web-browser, phone, and other applications. Additionally, various web sites, such as weather, “YouTube,” and other sites can be accessed directly by selecting the associated button on display region 502, which selection is detected by touch-screen interface 506.

It should be understood that touch-screen functionality associated with display region 502 can be provided on a variety of input devices, including a keyboard, a mobile telephone, a mouse, a graphics pad, and other input devices. In one possible graphics pad example, image data received from a computing system is projected onto a collimated glass component of the graphics pad to facilitate tracing by the user. Additionally, as discussed relative to FIG. 4, the displayed icons may automatically be reconfigured in response to either user selections, or events on the system to which input is provided. In some envisioned examples, the host system may initiate changes to the displayed icons (or other images) in response to inputs provided to the host system (opening a new program or file, selecting a function, etc.), and the inputs provided through the input device re-mapped in accordance with the displayed images. In analogous example, the input device itself might reconfigure one or more displayed images in response to user inputs.

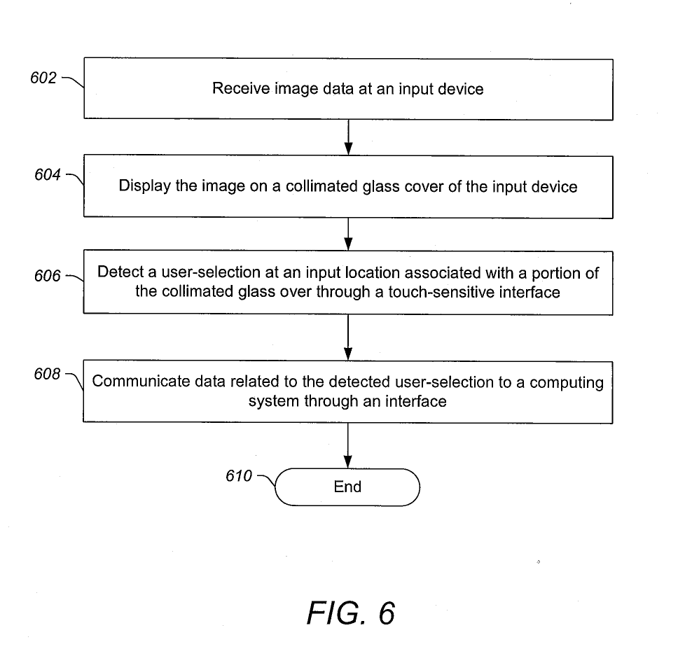

Referring now to FIG. 6, a flow chart 600 is depicted that provides an example of a method of displaying user-selectable images at an input device, such as mouse 218 of FIG. 2, mouse 400 of FIG. 4 and input device 500 of FIG. 5. At 602, an image is received at the input device. In one example, the input device is external to a computing system and configured to communicate with the computing system to receive the image data. In another instance, the image data may be stored on the input device, and the received data may be just selection data indicating the previously stored image to be displayed. In other applications the selection of the image data may be provided through the input device itself As previously described, the image data may range from a single color, such a might be generated by one or more LEDs, to one or more still or video images.

Advancing to 604, an image determined in accordance with the received image data will be displayed by an imaging device, which may be of any desired type, as set forth earlier herein. The displayed image will enter the collimated glass component at an input surface, as described above, and will then be displayed at a display surface of the component. For purposes of this example method, the collimated glass display surface will be understood to lie beneath a generally transparent touch screen interface.

Continuing to 606, a user-selection is detected at an input location associated with the touch-sensitive interface overlying the collimated glass display surface. As previously described, the touch-sensitive interface can be resistive, capacitive, or any other type of interface to detect user interactions, including contact, gesture, or other types of user-interactions.

Moving to 608, data related to the detected user-selection is communicated to a host computer through a host interface. In an example, the data may be raw sensed data derived from a contact sensor, such as a resistance level, a capacitance level, etc. In an example, the image displayed on the collimated glass component includes at least one user-selectable button and the communicated data includes user selection data. The method terminates at 610.

It should be understood that the method depicted in FIG. 6 is illustrative only, and is not intended to be limiting. Further, in some instances, image data is not received, but rather is generated within the input device, such as by a processor executing instructions to produce a graphical user interface. Additionally, in instances where the collimated glass component provides image data only and is not intended to be interactive, elements 606 and 608 can be omitted to the extent that they relate to the collimated glass component.

In conjunction with the systems and methods described above and depicted with respect to FIGS. 1-6, an input device is disclosed that includes a display assembly to display image data. In some examples, the display assembly includes a collimated glass component to translate the image from a display device at a first location to a display surface at a second location. In some embodiments, the input device is a computer mouse having a collimated glass component. Further, in some examples, the collimated glass component either includes or is associated with a touch-sensitive interface, allowing the collimated glass component to be used as a touch screen to display user-selectable options and to receive associated user selections, which can be communicated by the input device to an associated computing system.

Many additional modifications and variations may be made in the techniques and structures described and illustrated herein without departing from the spirit and scope of the present invention. For example, t should be understood that many variations may be made in the allocation of processing responsibilities. For example, it is possible to avoid any substantial processing of data within the input device by utilizing the processor of computing system 102 to perform signal processing and to generate the image data and by simply displaying received image data at the input device. In such an embodiment, sensor signals, such as signals related to user-interactions with an interaction-sensitive (touch-sensitive or light-sensitive) interface, may be processed only to an extent required for communication of the signals across the interface to computing system 102 for further processing by one or more processors within computing system 102.

Additionally, the described techniques may be used with additional sensor signals or measurements derived from such signals to refine detection of events creating data extraneous to the movement and other positioning information. Accordingly, the present invention should be clearly understood to be limited only by the scope of the claims and the equivalents thereof.

We claim:

1. A processing system input device, comprising:
a first mechanism configured to receive a user input to the processing system;
an interface to communicate the user input to the processing system; and
a collimated glass component having a visible display surface.

2. The input device of claim 1, wherein the collimated glass component comprises an input surface, and wherein the input device further comprises a display device proximate the collimated glass component input surface and arranged to translate an image received at the input surface to the display surface.

3. The input device of claim 2, wherein the collimated glass component is configured to alter the image received at the input surface for display at the display surface.

4. The input device of claim 3, wherein the collimated glass component is configured to magnify the received image.

5. The input device of claim 1, wherein the input surface comprises a translucent surface, and wherein the received image comprises reflected light from an underlying surface.

6. The input device of claim 1, further comprising a touch screen interface proximate the display surface of the collimated glass element.

7. The input device of claim 6, wherein the touch screen interface extends at least in part over the display surface of the collimated glass element.

10. An input device comprising:
an interface adapted to communicate with a system;
a collimated glass component comprising a plurality of fused optical fibers and a cover, the collimated glass component configured to project one or more images onto the cover.

11. The input device of claim 10, further comprising:
a first sensor to detect a motion direction of the input device relative to an underlying surface and in a plane defined by the underlying surface;
a second sensor to detect a speed of the input device relative to the underlying surface;
a touch-sensitive interface disposed over the cover to detect user interactions; and
a processor to provide data related to the motion direction, the speed, and the user interactions to the host system via the host interface.

12. The input device of claim 10, wherein the one or more images are received from the system through the interface.

13. The input device of claim 12, wherein the one or more images comprise a graphical user interface including at least one button.

14. The input device of claim 13, further a touch-sensitive interface to detect user interactions with the at least one button;
wherein data related to the detected user interactions are communicated to the system through the interface.

15. The input device of claim 13, further comprising a light-sensitive interface to generate signals related to user interaction with the at least one button.

16. A method or controlling an input device, comprising:
displaying a first image at the input device;
receiving a user input at the input device; and
in response to the received user input, displaying a second image at the input device.

17. The method of claim 16, wherein the input device comprises at least one of a computer mouse and a keyboard.

18. The method of claim 16, further comprising the act of receiving image data representative of the first image from a host computer through a host interface of the computer mouse.

19. The method of claim 16, wherein the input device comprises a collimated glass component, and wherein the act of receiving the image comprises capturing reflected light from an underlying surface.

20. The method of claim 16, wherein the input device comprises a collimated glass component, and further comprising the acts of:
detecting a user-selection at an input location associated with a portion of the collimated glass component through a touch-sensitive interface; and
communicating data related to the detected user-selection to a host computer through a host interface.

21. The method of claim 20, wherein the image displayed on the collimated glass component includes at least one user-selectable button; and
wherein the communicated data includes user selection data.

22. A data storage medium comprising processor readable instructions executable by a processor to project at least one image, the data storage medium including instructions executable by the processor to perform a method comprising:
receiving an image at a computer mouse; and
displaying the image on a collimated glass component of the computer mouse.

23. The data storage medium of claim 22, further comprising instructions executable by the processor to receive a graphical user interface from a host computer and to display the graphical user interface on the collimated glass component.

24. The data storage medium of claim 23, further comprising instructions executable by the processor to:
detect a user-selection at an input location associated with a portion of the collimated glass component through a touch-sensitive interface; and
communicate data related to the detected user-selection to a host computer through a host interface.

25. The data storage medium of claim 22, further comprising instructions executable by the processor to generate the image including at least one user-selectable button.

26. The data storage medium of claim 22, further comprising instructions executable by the processor to generate the image including at least one text label corresponding to a physical button.
